(19) United States
(12) Patent Application Publication
(10) Pub. No.: US 2023/0305693 A1
(43) Pub. Date: Sep. 28, 2023

(54) INTERNET-OF-THINGS DEVICE MANAGEMENT METHOD AND APPARATUS

(71) Applicant: HUAWEI TECHNOLOGIES CO., LTD., Shenzhen, Guangdong (CN)

(72) Inventor: Zejin GUO, Shanghai (CN)

(21) Appl. No.: 18/041,779

(22) PCT Filed: Aug. 4, 2021
(86) PCT No.: PCT/CN2021/110623

§ 371 Date: Feb. 15, 2023

(30) Foreign Application Priority Data
Aug. 18, 2020 (CN) 202010846926.8

(51) Int. Cl. G06F 3/0486; G06F 3/0488

(52) U.S. Cl. CPC G06F 3/0486; G06F 3/0488; G16Y 40/35

(57) ABSTRACT

Embodiments of this application provide an Internet-of-things device management method and apparatus. The method includes: obtaining a first triggering signal; displaying a virtual device interface based on the first triggering signal, where the virtual device interface includes virtual device information of at least two IoT devices; obtaining an operation signal, where the operation signal is a signal that is triggered by a user input in the virtual device interface and that is used to control interaction between the at least two IoT devices; and performing a processing operation corresponding to the operation signal.

This application claims priority to Chinese Patent Application No. 202010846926.8, filed with the China National Intellectual Property Administration on Aug. 18, 2020 and entitled “INTERNET-OF-THINGS DEVICE MANAGEMENT METHOD AND APPARATUS”, which is incorporated herein by reference in its entirety.

### TECHNICAL FIELD

Embodiments of this application relate to the field of electronic technologies, and specifically to an Internet-of-things device management method and apparatus.

### BACKGROUND

The Internet of things (Internet of things, IoT), that is, the internet where everything is connected, is a network that combines various sensors and the Internet to implement interconnection between people, machines, and things.

A method for managing an IoT device is to add an IoT device management list on a mobile phone, and manage the IoT device by using the IoT device management list. For example, a user starts an application (application, APP) for managing an IoT device, clicks a target IoT device icon in IoT device icons displayed on the APP, and then enters a management page of the target IoT device to select a corresponding function, so as to complete IoT device management.

In the conventional technology, IoT devices can only be separately managed, and a plurality of devices cannot be simultaneously controlled in one operation. Therefore, how to manage a plurality of IoT devices at the same time is a problem that needs to be solved currently.

### SUMMARY

Embodiments of this application provide an IoT device management method, so as to seamlessly switch a service between IoT devices.

According to a first aspect, an IoT device management method is provided, including: obtaining a first triggering signal; displaying a virtual device interface based on the first triggering signal, where the virtual device interface includes virtual device information of at least two IoT devices; obtaining an operation signal, where the operation signal is a signal that is triggered by a user in the virtual device interface and that is used to control interaction between the at least two IoT devices; and performing a processing method corresponding to the operation signal.

The apparatus for performing the method may be one of the at least two IoT devices, or may be an apparatus different from the at least two IoT devices. The first triggering signal may be an electrical signal generated by sliding a finger on a touchscreen, or may be a body action (for example, a two-finger folding action) captured by a camera of the apparatus for performing the method, or may be an infrared signal generated by a control apparatus such as a remote control. A specific form of the first triggering signal is not limited in this application. The virtual device interface may be an interface displayed on a screen of the apparatus for performing the method, or may be an interface displayed by the apparatus for performing the method by using an augmented reality (augmented reality, AR) technology or a virtual reality (virtual reality, VR) technology. The virtual device information may be information in an image form, or may be information in a text form. A specific form of the virtual device interface and the virtual device information is not limited in this application. Because the virtual device information of the at least two IoT devices is displayed in a same interface, the user may perform an operation on the virtual device interface to control the at least two IoT devices to interact. For example, the user may trigger, in a manner such as dragging or tapping, the device for performing the method to generate an operation signal, and the device for performing the method may control, based on the processing method corresponding to the operation signal, the at least two IoT devices to perform interaction such as device sharing and function migration. Based on the foregoing method, a user does not need to separately open management interfaces of different IoT devices to control interaction between different IoT devices, thereby implementing seamless service switching between IoT devices.

Optionally, the virtual device information of the at least two IoT devices includes virtual device icons and logical port icons of the at least two IoT devices.

Compared with the virtual device information in a text form, the virtual device information in an icon form is more intuitive, which can improve user experience.

Optionally, the at least two IoT devices include a first IoT device and a second IoT device, and the operation signal includes: The user drags a logical port icon of the first IoT device to a virtual device icon of the second IoT device. The performing a processing method corresponding to the operation signal includes: migrating a function corresponding to the logical port icon of the first IoT device to the second IoT device, where the second IoT device has the function corresponding to the logical port icon of the first IoT device.

The user may drag the logical port icon on the display of the first IoT device to generate the operation signal, or may drag the logical port icon in the VR interface or the AR interface to generate the operation signal. A specific manner of dragging the logical port icon to generate the operation signal is not limited in this application. In this embodiment, the logical port icon is, for example, a microphone icon, and a function corresponding to the microphone icon is a voice pickup function. The first IoT device may migrate the voice pickup function to the second IoT device, and transmit a voice of the user by using the microphone of the second IoT device. When the user is far away from the first IoT device and close to the second IoT device, a voice pickup effect can be improved. Therefore, in this embodiment, a user can obtain better experience by performing a simple operation (dragging an icon of a logical port) in a specific scenario.

Optionally, the at least two IoT devices include a first IoT device and a second IoT device, and the operation signal includes: The user drags a virtual device icon of the first IoT device to a virtual device icon of the second IoT device. The performing a processing method corresponding to the operation signal includes: migrating a function of a target application of the first IoT device to the second IoT device, where the target application is an application that is running on the first IoT device, and the target application is installed on the second IoT device.

The target application is, for example, a video chat APP. When the video chat APP is running on the first IoT device, the user may seamlessly migrate a function of the video chat APP to the second IoT device by dragging a virtual device icon of the first IoT device to a virtual icon of the second IoT device. The first IoT device is, for example, a smart television, and the second IoT device is, for example, a mobile phone. The user may implement more convenient video chat by using mobility of the mobile phone. Therefore, in this embodiment, a user can obtain better experience by performing a simple operation (dragging an icon of a virtual device) in a specific scenario.

Optionally, the at least two IoT devices include a first IoT device and a second IoT device, and the operation signal includes: The user drags a virtual device icon of the first IoT device to a virtual device icon of the second IoT device. The performing a processing method corresponding to the operation signal includes: establishing a communication connection between a target application of the first IoT device and a target application of the second IoT device, where the first IoT device does not run the target application before obtaining the operation signal.

When the first IoT device does not run the target application, the dragging operation of the user may be to establish a communication connection between the target application of the first IoT device and the target application of the second IoT device. The target application may be a preset APP, or may be an APP selected by the user in real time. When the target application is a video chat APP, the user can implement video chat between the first IoT device and the second IoT device without opening the video chat APP. Therefore, in this embodiment, a user can obtain better experience by performing a simple operation (dragging an icon of a virtual device) in a specific scenario.

Optionally, the at least two IoT devices include a first IoT device and a second IoT device, and the operation signal includes: The user drags, with two fingers, a logical port icon of the first IoT device and a logical port icon of the second IoT device for combination. The performing a processing method corresponding to the operation signal includes: sharing a function of the logical port icon of the first IoT device and a function of the logical port icon of the second IoT device.

The user can drag the port icons of the two logical devices to share functions of logical ports. For example, when a user A is performing a video call with a user C by using a mobile phone, and a user B wants to join the video call by using a smart television, the user A may drag a microphone icon of the mobile phone and a microphone icon of the smart television to enable the user B join the video call. In this embodiment, a user can obtain better experience by performing a simple operation (dragging an icon of a logical port of a virtual device) in a specific scenario.

Optionally, the at least two IoT devices include a first IoT device and a second IoT device, and the operation signal includes: The user taps a virtual device icon of the second IoT device. The performing a processing method corresponding to the operation signal includes: establishing a control event mapping relationship between the first IoT device and the second IoT device, where the first IoT device is a preset control device, and the second IoT device is a controlled device.

The first IoT device is, for example, a smart television, and the second IoT device is, for example, a mobile phone. The user may control the smart television by using the mobile phone. For example, the user may enter a website address in a browser of the smart television by using a mobile phone keyboard. Compared with controlling the smart television by using a remote control, in this embodiment, the user can obtain better experience in a specific scenario.

Optionally, the obtaining a first triggering signal includes: obtaining the first triggering signal by using a touchscreen, where the first triggering signal is a triggering signal generated when the user performs a preset action on the touchscreen.

Optionally, the obtaining a first triggering signal includes: obtaining the first triggering signal by using a camera, where the first triggering signal is a triggering signal generated when the user performs a preset action in the air.

Optionally, the method further includes: exiting the virtual device interface.

Optionally, the exiting the virtual device interface includes: obtaining a second triggering signal; and exiting the virtual device interface based on the second triggering signal.

According to a second aspect, an IoT device management apparatus is provided, including a unit including software and/or hardware. The unit is configured to perform any method in the technical solution according to the first aspect.

According to a third aspect, an electronic device is provided, including a processor and a memory, where the memory is configured to store a computer program, and the processor is configured to invoke the computer program from the memory and run the computer program, so that the electronic device performs any method in the technical solution according to the first aspect.

According to a fourth aspect, a computer-readable medium is provided, where the computer-readable program stores program code. When the computer program code is run on an electronic device, the electronic device is enabled to perform any method in the technical solution according to the first aspect.

According to a fifth aspect, a computer program product is provided, where the computer program product includes computer program code, and when the computer program code is run on an electronic device, the electronic device is enabled to perform any method in the technical solution according to the first aspect.

### BRIEF DESCRIPTION OF DRAWINGS

FIG. 1 is a schematic diagram of an IoT system applicable to an embodiment of this application;

FIG. 2 is a schematic diagram of a hardware system of an IoT device according to an embodiment of this application;

FIG. 3 is a schematic diagram of a software system of an IoT device according to an embodiment of this application;

FIG. 4 is a schematic diagram of a topology structure of logical devices of several IoT devices according to an embodiment of this application;

FIG. 5 shows a method for entering a logical device display interface by using a smart television according to an embodiment of this application;

FIG. 6 shows a method for entering a logical device display interface by using a mobile phone according to an embodiment of this application;

FIG. 7 shows another method for entering a logical device display interface by using a mobile phone according to an embodiment of this application;

FIG. 8 is a schematic diagram of a logical device display interface according to an embodiment of this application;

FIG. 9 is a schematic diagram of a method for setting a video call according to an embodiment of this application;

FIG. 10 is a schematic diagram of a method for setting sharing of a Bluetooth headset according to an embodiment of this application;

FIG. 11 is a schematic diagram of another method for setting a video call according to an embodiment of this application;

FIG. 12 is a schematic diagram of another method for setting a multi-party video call according to an embodiment of this application;

FIG. 13 is a schematic diagram of a method for setting a camera according to an embodiment of this application;

FIG. 14 is a schematic diagram of a method for migrating an APP function according to an embodiment of this application;

FIG. 15 is a schematic diagram of another method for migrating an APP function according to an embodiment of this application;

FIG. 16A and FIG. 16B are a schematic diagram of a method for establishing a video call according to an embodiment of this application;

FIG. 17 is a schematic diagram of another method for establishing a video call according to an embodiment of this application;

FIG. 18 is a schematic diagram of a method for controlling a smart television by using a mobile phone according to an embodiment of this application; and

FIG. 19 is a schematic diagram of an electronic device for managing an IoT device according to an embodiment of this application.

### DESCRIPTION OF EMBODIMENTS

The following describes technical solutions of embodiments in this application with reference to accompanying drawings.

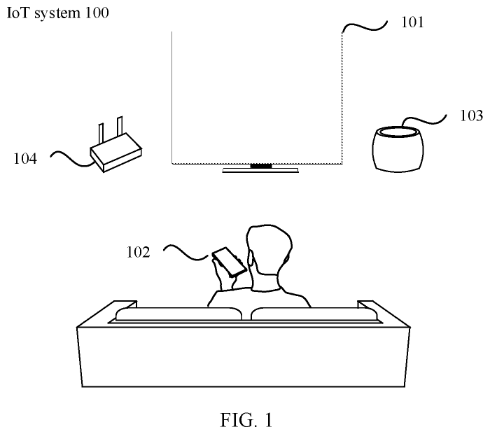

FIG. 1 is a schematic diagram of an IoT system 100 applicable to an embodiment of this application. The IoT system 100 includes a smart television 101, a mobile phone 102, a smart sound box 103, and a router 104. These devices may be referred to as IoT devices.

A user may send an instruction to the smart television 101 by using the mobile phone 102. The instruction is forwarded to the smart television 101 by using the router 104. The smart television 101 performs a corresponding operation based on the instruction, for example, turning on a camera, a screen, a microphone, and a speaker.

The user may also send an instruction to the smart sound box 103 by using the mobile phone 102. The instruction is transmitted to the smart sound box 103 by using a Bluetooth connection between the mobile phone 102 and the smart sound box 103, and the smart sound box 103 performs a corresponding operation based on the instruction, for example, turning on a microphone and a speaker.

The IoT system 100 is an example rather than all of the IoT systems applicable to this application. For example, in the IoT system applicable to this embodiment of this application, IoT devices may further communicate with each other in a wired connection manner. A user may control the smart television 101 and the smart sound box 103 by using an AR device or a VR device.

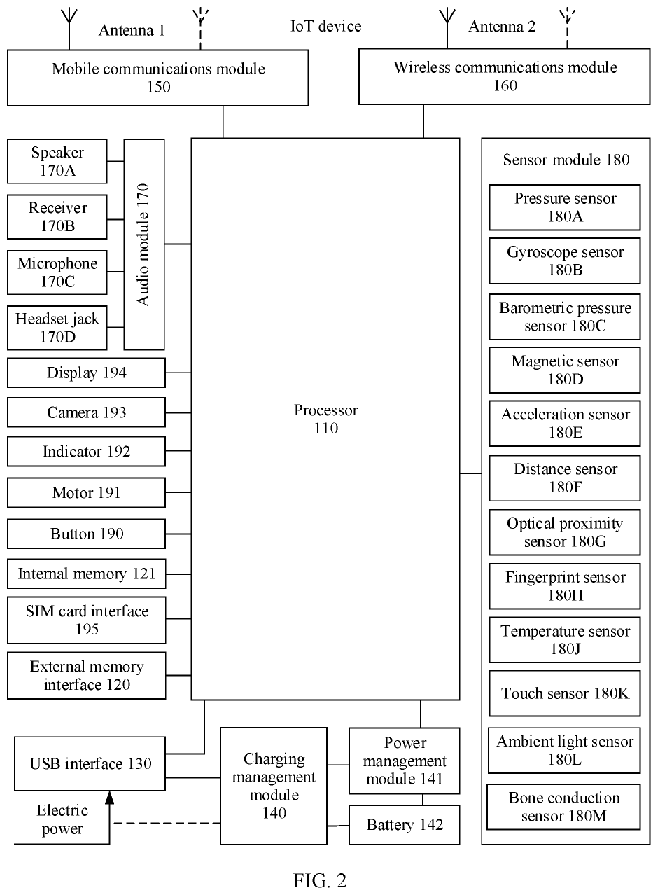

FIG. 2 is used as an example to describe a hardware structure of an IoT device according to an embodiment of this application.

The IoT device may include a processor 110, an external memory interface 120, an internal memory 121, a universal serial bus (universal serial bus, USB) interface 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It should be noted that the structure shown in FIG. 2 does not constitute a specific limitation on the IoT device. In some other embodiments of this application, the IoT device may include components more or fewer than those shown in FIG. 2, or the IoT device may include a combination of some components in the components shown in FIG. 2, or the IoT device may include subcomponents of some components in the components shown in FIG. 2. The components shown in FIG. 2 may be implemented by hardware, software, or a combination of software and hardware.

The processor 110 may include one or more processing units. The processor 110 may include at least one of the following processing units: an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and a neural-network processing unit (neural-network processing unit, NPU). Different processing units may be independent components, or may be integrated components.

The controller may generate an operation control signal based on an instruction operation code and a time sequence signal, to complete control of instruction fetching and instruction execution.

A memory may be further disposed in the processor 110, and is configured to store instructions and data. In some embodiments, the memory in the processor 110 is a cache memory. The memory may store an instruction or data that has been used or cyclically used by the processor 110. If the processor 110 needs to use the instruction or the data again, the processor may directly invoke the instruction or the data from the memory. This avoids repeated access, reduces waiting time of the processor 110, and improves system efficiency.

In some embodiments, the processor 110 may include one or more interfaces. For example, the processor 110 may include at least one of the following interfaces: an inter-integrated circuit (inter-integrated circuit, I2C) interface, an inter-integrated circuit audio (inter-integrated circuit sound, I2S) interface, a pulse code modulation (pulse code modulation, PCM) interface, a universal asynchronous receiver transmitter (universal asynchronous receiver/transmitter, UART) interface, a mobile industry processor interface (mobile industry processor interface, MIPI), a universal input/output (general-purpose input/output, GPIO) interface, a SIM interface, and a USB interface.

The I2C interface is a two-way synchronization serial bus, and includes one serial data line (serial data line, SDA) and one serial clock line (serial clock line, SCL). In some embodiments, the processor 110 may include a plurality of I2C buses. The processor 110 may be separately coupled to the touch sensor 180K, a charger, a flash, the camera 193, and the like through different I2C bus interfaces. For example, the processor 110 may be coupled to the touch sensor 180K by using an I2C interface, so that the processor 110 communicates with the touch sensor 180K by using the I2C bus interface, to implement a touch function of the IoT device.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communications module 160 through the I2S interface, to implement a function of answering a call through a Bluetooth headset.

The PCM interface may also be used for audio communication, and samples, quantizes, and encodes an analog signal. In some embodiments, the audio module 170 may be coupled to the wireless communications module 160 through a PCM bus interface. In some embodiments, the audio module 170 may also transmit an audio signal to the wireless communications module 160 through the PCM interface, to implement a function of answering a call through a Bluetooth headset. Both the I2S interface and the PCM interface may be used for audio communication.

The UART interface is a universal serial data bus used for asynchronous communication. The bus may be a two-way communications bus. The bus converts to-be-transmitted data between serial communication and parallel communication. In some embodiments, the UART interface is usually configured to connect the processor 110 to the wireless communications module 160. For example, the processor 110 communicates with a Bluetooth module in the wireless communications module 160 through the UART interface, to implement a Bluetooth function. In some embodiments, the audio module 170 may transmit an audio signal to the wireless communications module 160 through the UART interface, to implement a function of playing music through a Bluetooth headset.

The MIPI interface may be configured to connect the processor 110 to peripheral components such as the display 194 and the camera 193. The MIPI interface includes a camera serial interface (camera serial interface, CSI), a display serial interface (display serial interface, DSI), and the like. In some embodiments, the processor 110 communicates with the camera 193 through the CSI, to implement a photographing function of the IoT device. The processor 110 communicates with the display 194 through the DSI interface, to implement a display function of the IoT device.

The GPIO interface may be configured by software. The GPIO interface may be configured as a control signal interface, or may be configured as a data signal interface. In some embodiments, the GPIO interface may be configured to connect the processor 110 to the camera 193, the display 194, the wireless communications module 160, the audio module 170, and the sensor module 180. The GPIO interface may be further configured as an I2C interface, an I2S interface, a UART interface, or an MIPI interface.

The USB interface 130 is an interface that conforms to a USB standard specification, for example, may be a mini (Mini) USB interface, a micro (Micro) USB interface, or a USB Type C (USB Type C) interface. The USB interface 130 may be configured to connect to a charger to charge the IoT device, or may be configured to transmit data between the IoT device and a peripheral device, or may be configured to connect to a headset to play audio by using the headset. The USB interface 130 may be further configured to connect to another electronic device, for example, an AR device.

A connection relationship between the modules shown in FIG. 2 is merely used as an example for description, and does not constitute a limitation on the connection relationship between the modules of the IoT device. Optionally, the modules of the IoT device may also use a combination of a plurality of connection manners in the foregoing embodiment.

The charging management module 140 is configured to receive electricity from a charger. The charger may be a wireless charger or a wired charger. In some embodiments of wired charging, the charging management module 140 may receive electricity of a wired charger through the USB interface 130. In some embodiments of wireless charging, the charging management module 140 may receive an electromagnetic wave (a current path is shown by a dashed line) by using a wireless charging coil of the IoT device. The charging management module 140 supplies power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communications module 160, and the like. The power management module 141 may be further configured to monitor parameters such as a battery capacity, a battery cycle count, and a battery health status (electric leakage or impedance). Optionally, the power management module 141 may be disposed in the processor 110, or the power management module 141 and the charging management module 140 may be disposed in a same device.

A wireless communications function of the IoT device may be implemented through components such as the antenna 1, the antenna 2, the mobile communications module 150, the wireless communications module 160, the modem processor, and the baseband processor.

The antenna 1 and the antenna 2 are configured to transmit and receive an electromagnetic wave signal. Each antenna in the IoT device may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communications module 150 may provide a wireless communication solution applied to the IoT device, for example, at least one of the following solutions: a 2nd generation (2nd generation, 2G) mobile communications solution, a 3rd generation (3rd generation, 3G) mobile communications solution, a 4th generation (4th generation, 5G) mobile communications solution, or a 5th generation (5th generation, 5G) mobile communications solution. The mobile communications module 150 may include at least one filter, a switch, a power amplifier, a low noise amplifier (low noise amplifier, LNA), and the like. The mobile communications module 150 may receive an electromagnetic wave through the antenna 1, perform processing such as filtering or amplification on the received electromagnetic wave, and then transmit the electromagnetic wave to the modem processor for demodulation. The mobile communications module 150 may further amplify a signal modulated by the modem processor, and the amplified signal is converted into an electromagnetic wave by using the antenna 1 for radiation. In some embodiments, at least some functional modules in the mobile communications module 150 may be disposed in the processor 110. In some embodiments, at least some functional modules of the mobile communications module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by using an audio device (for example, the speaker 170A or the receiver 170B), or displays an image or a video by using the display 194. In some embodiments, the modem processor may be an independent component. In some other embodiments, the modem processor may be independent of the processor 110, and is disposed in a same device as the mobile communications module 150 or another functional module.

Similar to the mobile communications module 150, the wireless communications module 160 may also provide a wireless communications solution applied to the IoT device, for example, at least one of the following solutions: a wireless local area network (wireless local area networks, WLAN), Bluetooth (Bluetooth, BT), a global navigation satellite system (global navigation satellite system, GNSS), frequency modulation (frequency modulation, FM), near field communication (near field communication, NFC), and infrared (infrared, IR). The wireless communications module 160 may be one or more components integrating at least one communications processor module. The wireless communications module 160 receives an electromagnetic wave by using the antenna 2, performs frequency modulation and filtering processing on an electromagnetic wave signal, and sends a processed signal to the processor 110. The wireless communications module 160 may further receive a to-be-sent signal from the processor 110, perform frequency modulation and amplification on the signal, and convert the signal into an electromagnetic wave by using the antenna 2 for radiation.

In some embodiments, the antenna 1 of the IoT device is coupled to the mobile communications module 150, and the antenna 2 of the IoT device is coupled to the wireless communications module 160.

The IoT device implements a display function by using the GPU, the display 194, and the application processor. The GPU is a microprocessor for image processing, and is connected to the display 194 and the application processor. The GPU is configured to: perform mathematical and geometric computation, and render an image. The processor 110 may include one or more GPUs, which execute program instructions to generate or change display information.

The display 194 is configured to display an image or a video. The display 194 includes a display panel. The display panel may be a liquid crystal display (liquid crystal display, LCD), an organic light emitting diode (organic light-emitting diode, OLED), an active matrix organic light emitting diode (active-matrix organic light-emitting diode, AMOLED), a flexible light emitting diode (flex light-emitting diode, FLED), a mini light emitting diode (mini light-emitting diode, Mini LED), a mini light emitting diode (micro light-emitting diode, Micro LED), a micro OLED (Micro OLED), or a quantum dot light emitting diode (quantum dot light emitting diodes, QLED). In some embodiments, the IoT device may include one or N displays 194, where N is a positive integer greater than 1.

The IoT device may implement a photographing function by using the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may optimize an algorithm for noise, brightness, and color of an image, and may further optimize parameters such as exposure and color temperature of a shooting scenario. In some embodiments, the ISP may be disposed in the camera 193.

The camera 193 is configured to capture a static image or a video. An optical image of an object is generated through the lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into standard red, green, blue (red green blue, RGB), and YUV image signals. In some embodiments, the IoT device may include one or N cameras 193, where N is a positive integer greater than 1.

The digital signal processor is configured to process a digital signal, and may process another digital signal in addition to the digital image signal. For example, when the IoT device selects a frequency, the digital signal processor is configured to perform Fourier transform on frequency energy.

The video codec is configured to compress or decompress a digital video. The IoT device may support one or more video codecs. In this way, the IoT device may play or record videos in a plurality of encoding formats, for example, dynamic picture expert group (moving picture experts group, MPEG) 1, MPEG2, MPEG3, and MPEG4.

The NPU is a processor that uses a structure of a biological neural network as a reference. For example, the NPU quickly processes input information by using a transmission mode between human brain neurons, and may further continuously perform self-learning. The NPU can implement intelligent recognition of the IoT device, such as image recognition, facial recognition, speech recognition, and text understanding.

The external memory interface 120 may be configured to connect to an external storage card, for example, a secure digital (secure digital, SD) card, to extend a storage capability of the IoT device. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system and an application required by at least one function (for example, a sound playing function and an image playing function). The data storage area may store data (such as audio data and a phone book) created during use of the IoT device. In addition, the internal memory 121 may include a high-speed random access memory, or may include a nonvolatile memory, for example, at least one magnetic disk storage device, a flash memory, a universal flash storage (universal flash storage, UFS), and the like. The processor 110 runs instructions stored in the internal memory 121 and/or instructions stored in a memory disposed in the processor, to perform various function applications and data processing that are of the IoT device.

The IoT device may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may be further configured to code and decode an audio signal. In some embodiments, the audio module 170 or some function modules of the audio module 170 may be disposed in the processor 110.

The speaker 170A, also referred to as a speaker, is configured to convert an audio electrical signal into a sound signal. The IoT device may listen to music or make a hands-free call through the speaker 170A.

The receiver 170B, also referred to as an earpiece, is configured to convert an audio electrical signal into a sound signal. When a user uses the IoT device to answer a call or receive voice information, the user may answer the voice by placing the receiver 170B close to an ear.

The microphone 170C, also referred to as a mike or a mic, is configured to convert a sound signal into an electrical signal. When a user makes a call or sends voice information, a sound signal may be input to the microphone 170C by making a voice close to the microphone 170C. At least one microphone 170C may be disposed in the IoT device. In some other embodiments, the IoT device may be provided with two microphones 170C, to implement a noise reduction function. In some other embodiments, three, four, or more microphones 170C may be disposed in the IoT device, to implement functions such as identifying a sound source and performing directional recording.

The headset jack 170D is configured to connect to a wired headset. The headset jack 170D may be the USB interface 130, or may be a 3.5 mm open mobile terminal platform (open mobile terminal platform, OMTP) standard interface or a cellular telecommunications industry association of the USA (cellular telecommunications industry association of the USA, CTIA) standard interface.

The pressure sensor 180A is configured to sense a pressure signal, and can convert the pressure signal into an electrical signal. In some embodiments, the pressure sensor 180A may be disposed on the display 194. There are a plurality of types of the pressure sensor 180A, for example, the pressure sensor 180A may be a resistive pressure sensor, an inductive pressure sensor, or a capacitive pressure sensor. The capacitive pressure sensor may be a parallel plate including at least two conductive materials. When a force is applied to the pressure sensor 180A, a capacitance between electrodes changes, and the IoT device determines a strength of the pressure based on a capacitance change. When a touch operation is performed on the display 194, the IoT device detects the touch operation based on the pressure sensor 180A. The IoT device may also calculate a touch position based on a detection signal of the pressure sensor 180A. In some embodiments, touch operations that are performed in a same touch position but have different touch operation intensity may correspond to different operation instructions. For example, when a touch operation whose touch operation strength is less than a first pressure threshold acts on an icon of an SMS application, an instruction for viewing an SMS message is executed; or when a touch operation whose touch operation strength is greater than or equal to the first pressure threshold acts on the icon of the SMS application, an instruction for creating an SMS message is executed.

The gyroscope sensor 180B may be configured to determine a moving posture of the IoT device. In some embodiments, an angular velocity of the IoT device around three axes (namely, axes x, y, and z) may be determined through the gyroscope sensor 180B. The gyroscope sensor 180B may be configured to perform image stabilization during photographing. For example, when a shutter is pressed, the gyroscope sensor 180B detects an angle at which the IoT device jitters, calculates, based on the angle, a distance for which a lens module needs to compensate, and allows the lens to cancel the jitter of the IoT device through reverse motion, to implement image stabilization. The gyroscope sensor 180B may be further used for scenarios such as navigation and a motion sensing game.

The barometric pressure sensor 180C is configured to measure barometric pressure. In some embodiments, the IoT device calculates an altitude by using atmospheric pressure measured by the barometric pressure sensor 180C, to assist in positioning and navigation.

The magnetic sensor 180D includes a Hall sensor. The IoT device may detect opening and closing of a leather case by using the magnetic sensor 180D. In some embodiments, when the IoT device is a clamshell phone, the IoT device may detect opening and closing of a flip based on the magnetic sensor 180D. The IoT device can set features such as automatic unlocking of the flip cover based on the detected opening and closing status of the leather case or flip cover.

The acceleration sensor 180E may detect magnitude of acceleration of the IoT device in each direction (generally an x-axis, a y-axis, and a z-axis). When the IoT device is still, a magnitude and a direction of gravity can be detected. The acceleration sensor 180E may be further configured to identify a posture of the IoT device, and be used as an input parameter of an application such as landscape/portrait orientation switching and a pedometer.

The distance sensor 180F is configured to measure a distance. The IoT device can measure the distance by using infrared light or laser. In some embodiments, for example, in a photographing scenario, the IoT device may perform ranging by using the distance sensor 180F to implement fast focusing.

The optical proximity sensor 180G may include, for example, a light-emitting diode (light-emitting diode, LED) and an optical detector, for example, a photodiode. The LED may be an infrared LED. The IoT device emits infrared light through the LED. The IoT device detects infrared reflected light from a nearby object by using the photodiode. When the reflected light is detected, the IoT device may determine that an object exists nearby. When no reflected light is detected, the IoT device may determine that no object exists nearby. The IoT device may detect, by using the optical proximity sensor 180G, whether the user holds the IoT device close to an ear to make a call, so as to automatically turn off the screen to save power. The optical proximity sensor 180G may also be used for automatic unlocking and automatic screen locking in a smart cover mode or a pocket mode.

The ambient light sensor 180L is configured to sense ambient light brightness. The IoT device may adaptively adjust the brightness of the display 194 based on the sensed ambient light brightness. The ambient light sensor 180L may also be configured to automatically adjust white balance during photographing. The ambient light sensor 180L may further cooperate with the optical proximity sensor 180G to detect whether the IoT device is in a pocket, to prevent an accidental touch.

The fingerprint sensor 180H is configured to collect a fingerprint. The IoT device can use the collected fingerprint feature to implement functions such as unlocking, accessing the app lock, taking photos, and answering calls.

The temperature sensor 180J is configured to detect a temperature. In some embodiments, the IoT device executes a temperature processing policy by using the temperature detected by the temperature sensor 180J. For example, when the temperature reported by the temperature sensor 180J exceeds a threshold, the IoT device lowers performance of a processor located near the temperature sensor 180J, to reduce power consumption to implement thermal protection. In some other embodiments, when the temperature is lower than another threshold, the IoT device heats the battery 142 to avoid abnormal shutdown of the terminal device caused by a low temperature. In some other embodiments, when the temperature is lower than still another threshold, the IoT device boosts an output voltage of the battery 142, to avoid abnormal shutdown caused by a low temperature.

The touch sensor 180K is also referred to as a touch component. The touch sensor 180K may be disposed in the display 194, and the touch sensor 180K and the display 194 constitute a touchscreen, which is also referred to as a touch screen. The touch sensor 180K is configured to detect a touch operation performed on or near the touch sensor 180K. The touch sensor 180K may transfer the detected touch operation to the application processor to determine a touch event type. Visual output related to the touch operation may be provided by using the display 194. In some other embodiments, the touch sensor 180K may also be disposed on a surface of the IoT device, and is disposed at a position different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal. In some embodiments, the bone conduction sensor 180M may also be disposed in the headset, to obtain a bone conduction headset. The audio module 170 may obtain a speech signal through parsing based on the vibration signal that is of the vibration bone of the vocal-cord part and that is obtained by the bone conduction sensor 180M, to implement a speech function. The application processor may parse heart rate information based on the blood pressure beating signal obtained by the bone conduction sensor 180M, to implement a heart rate detection function.

The button 190 includes a power button and a volume button. The button 190 may be a mechanical button, or may be a touch button. The IoT device can receive a key input signal to implement a function related to a case input signal.

The motor 191 may generate vibration. The motor 191 may be used for an incoming call prompt, or may be used for touch feedback. The motor 191 may generate different vibration feedback effects for touch operations performed on different applications. For touch operations performed on different areas of the display 194, the motor 191 may also generate different vibration feedback effects. Different application scenarios (for example, a time reminder, information receiving, an alarm clock, and a game) may also correspond to different vibration feedback effects. The touch vibration feedback effect may be further customized.

The indicator 192 may be an indicator light, and may be configured to indicate a charging status and a power change, or may be configured to indicate a message, a missed call, and a notification.

The SIM card interface 195 is configured to connect to a SIM card. The SIM card may be inserted into the SIM card interface 195 to implement contact with the IoT device, or may be removed from the SIM card interface 195 to implement separation from the IoT device. The IoT device may support one or N SIM card interfaces, where N is a positive integer greater than 1. A plurality of cards may be inserted into a same SIM card interface 195 at the same time, and types of the plurality of cards may be the same or may be different. The SIM card interface 195 is also compatible with an external storage card. The IoT device interacts with a network through the SIM card to implement functions such as calling and data communication. In some embodiments, the IoT device uses an embedded SIM (embedded-SIM, eSIM) card. The eSIM card may be embedded in the IoT device, and cannot be separated from the IoT device.

The foregoing describes in detail the hardware system of the IoT device, and the following describes a software system of the IoT device provided in embodiments of this application. The software system of the IoT device may use a layered architecture, an event-driven architecture, a microkernel architecture, a microservice architecture, or a cloud architecture. In this embodiment of this application, the layered architecture is used as an example to describe the software system of the IoT device.

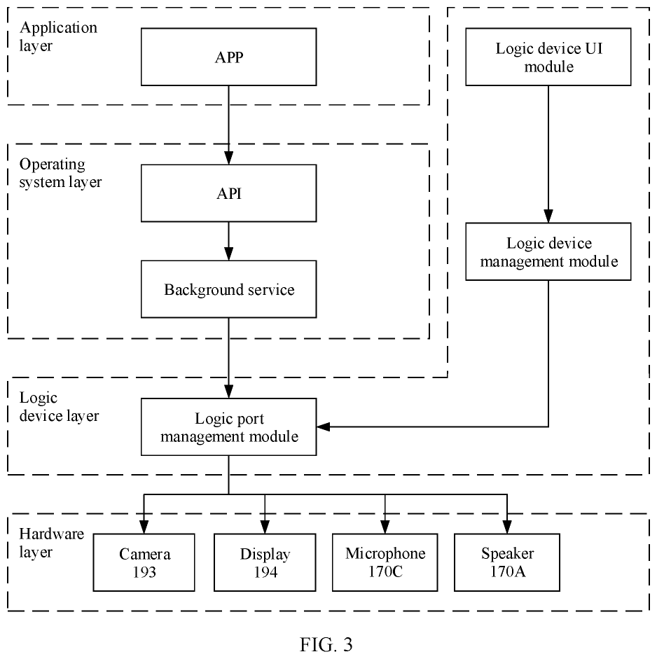

As shown in FIG. 3, a layered architecture divides software into several layers, each with a clear role and division of labor. The layers communicate with each other through a software interface. In some embodiments, the software system is divided into three layers that are respectively an application layer, an operating system layer, and a logical device layer from top to bottom.

The application layer may include applications such as Camera, Gallery, Calendar, Call, Map, Navigation, WLAN, Bluetooth, Music, Video, Messages. In some IoT devices with weak device capabilities, the application layer may also exist in a form of a software development kit (software development kit, SDK).

The operating system layer provides an application programming interface (application programming interface, API) and a background service for an APP at the application layer. The background service is, for example, some predefined functions.

When the user performs a touch operation on the touch sensor 180K, corresponding hardware interruption is sent to the operating system layer. The operating system layer processes the touch operation into an original input event, where the original input event includes, for example, information such as touch coordinates and a time stamp of the touch operation. Then, the operating system layer identifies a control corresponding to the original access event, and notifies an APP corresponding to the control. For example, the touch operation is a tap operation, and the APP corresponding to the control is a camera APP. In this case, the camera APP may invoke a background service by using an API, transmit a control instruction to a logical port management module, and control, by using the logical port management module, the camera 193 to perform photographing.

The logical device layer includes the logical device port management module, a logical device management module, and a logical device user interface (user interface, UI) module.

The logical port management module is used to manage routes of logical ports, share and reference functions of the logical ports, and reference ports of remote IoT devices through network connections. For example, when the mobile phone 102 uses a camera of the smart television 101 (a remote IoT device), the smart television 101 sets a state of a camera function to be shareable, and a logical port management module of the mobile phone 102 references the camera function of the smart television 101 by using a network connection. Then, an APP on the mobile phone 102 may perform an operation such as video chat by using the camera of the smart television 101.

Functions of the logical device management module include adding and deleting IoT devices and managing device permissions.

The logical device UI module is configured to display a logical device list to a user in a visualized manner, so that the user manages an IoT device.

For example, when the user sets the mobile phone 102 to use a local microphone 1, user operation information obtained by the logical device UI module is transmitted to the logical device management module. The logical device management module may activate a function/dev/mic1 based on the user operation information to add the microphone 1 to a logical device list, and the logical port management module may perform voice pickup by using a port of the microphone 1. When the user sets the mobile phone 102 to use a microphone 2 of the smart television 101, the logical device management module may activate a function/dev/mic2 to add the microphone 2 to the logical device list, and the logical port management module may perform voice pickup by using a port of the microphone 2.

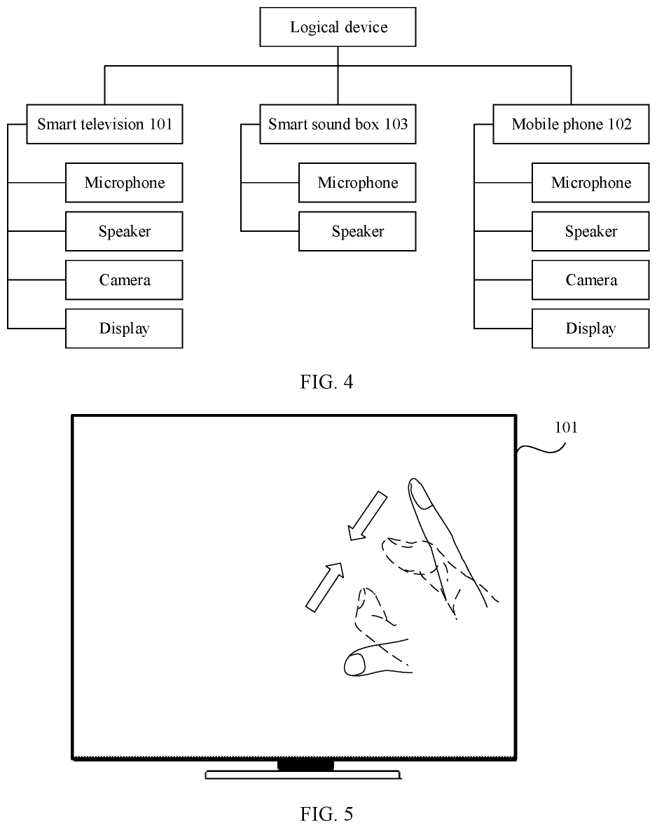

To facilitate IoT device control, the IoT device may be virtualized as a logical device. A topology structure of logical devices of the smart television 101, the mobile phone 102, and the smart sound box 103 is shown in FIG. 4.

Modules that have a user interaction function in modules included in the smart television 101 and the mobile phone 102 are usually a microphone, a speaker, a camera, and a screen. Therefore, logical devices of the smart television 101 and the mobile phone 102 may include logical ports corresponding to the foregoing modules.

Modules that have a user interaction function in modules included in the smart sound box 103 are usually a microphone and a speaker. Therefore, logical ports included in a logical device of the smart sound box 103 may be a microphone and a speaker.

The topology structure shown in FIG. 4 may be generated by the mobile phone 102.

The mobile phone 102 may send indication information to the smart television 101 and the smart sound box 103, to indicate the smart television 101 and the smart sound box 103 to report respective capability information. The capability information indicates a function supported by each IoT device. For example, capability information reported by the smart television 101 indicates that functions supported by the smart television 101 include a microphone, a speaker, a camera, and a screen, and capability information reported by the smart sound box 103 indicates that functions supported by the smart sound box include a microphone and a speaker.

The mobile phone 102 may also send a query request to a server to obtain the capability information of the smart television 101 and the smart sound box 103 from the server based on a device brand and/or a device model.

In addition, when the mobile phone 102 logs in to a same management account as the smart television 101 and the smart sound box 103, the mobile phone 102 may synchronize capability information of the smart television 101 and the smart sound box 103. For example, the smart television 101 and the smart sound box 103 may periodically send capability information to the mobile phone 102, or the mobile phone 102 periodically queries capabilities of the smart television 101 and the smart sound box 103, or the smart television 101 and the smart sound box 103 send capability information to the mobile phone 102 when functions supported by the smart television 101 and the smart sound box 103 change.

In some possible implementations, a device status (for example, a quantity of electricity of a logical device, whether a screen of the logical device is turned off, and whether a logical port is occupied) further needs to be synchronized between devices. For a synchronization manner, optionally, refer to synchronization of capability information. This is not limited in this application.

The user may enter a logical device display interface by using the smart television 101 or the smart sound box 103. Regardless of which IoT device enters the logical device display interface, the user may view a status of each IoT device, and may manage each IoT device in a same manner.

The following describes, by using the smart television 101 or the mobile phone 102 as an example, a method for entering a logical device display interface provided in this application.

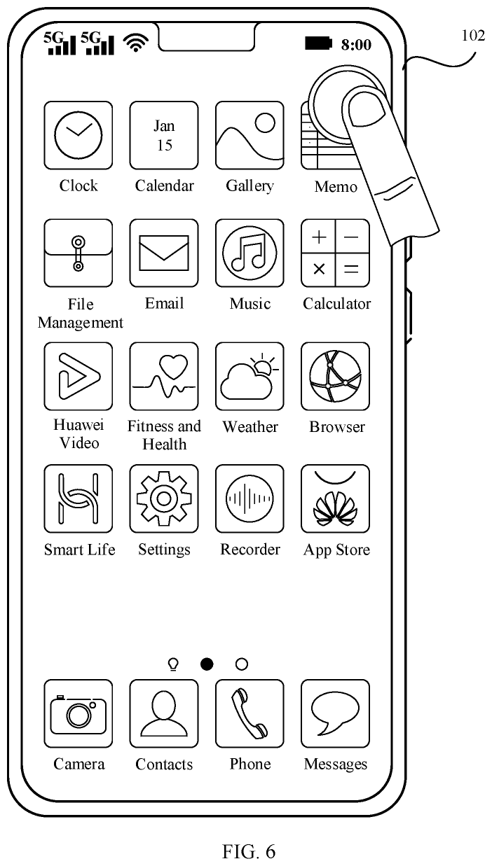

FIG. 5 shows a method for entering a logical device display interface by using a smart television 101.

A user may perform a two-finger folding action when the smart television 101 is in any display interface. The action is used to trigger the smart television 101 to enter the logical device display interface. The smart television 101 may capture the two-finger folding action by using a camera, or may capture the two-finger folding action by using a screen with a touch function. That is, the user may perform the two-finger folding action in the air, and trigger, by using the camera, the smart television 101 to enter the logical device display interface, or the user may perform the two-finger folding action on a screen with a touch function, and trigger, by using the screen, the smart television 101 to enter the logical device display interface.

After detecting the two-finger folding action, a processor of the smart television 101 may zoom out a current display interface, and display a small-sized image of the current display interface on the screen as a logical device of the smart television 101.

The user may further trigger, by using a voice, a remote control, or another action, the smart television 101 to enter the logical device display interface. A specific manner of triggering the smart television 101 to enter the logical device display interface is not limited in this application.

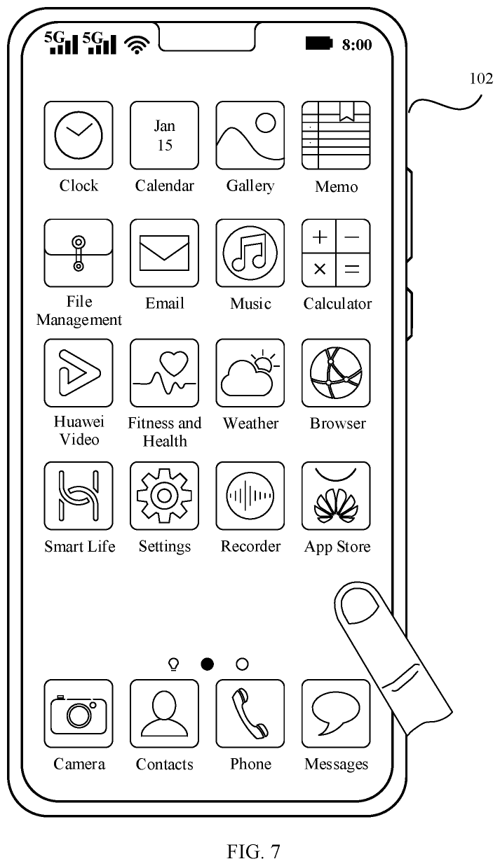

FIG. 6 shows a method for entering the logical device display interface by using a mobile phone 102.

The user may tap or double-tap a floating button when the mobile phone 102 is in any display interface, and tap or double-tap the floating button to trigger the mobile phone 102 to enter the logical device display interface. The floating button may be set to a semi-transparent state, and may be dragged to any position on the screen of the mobile phone 102.

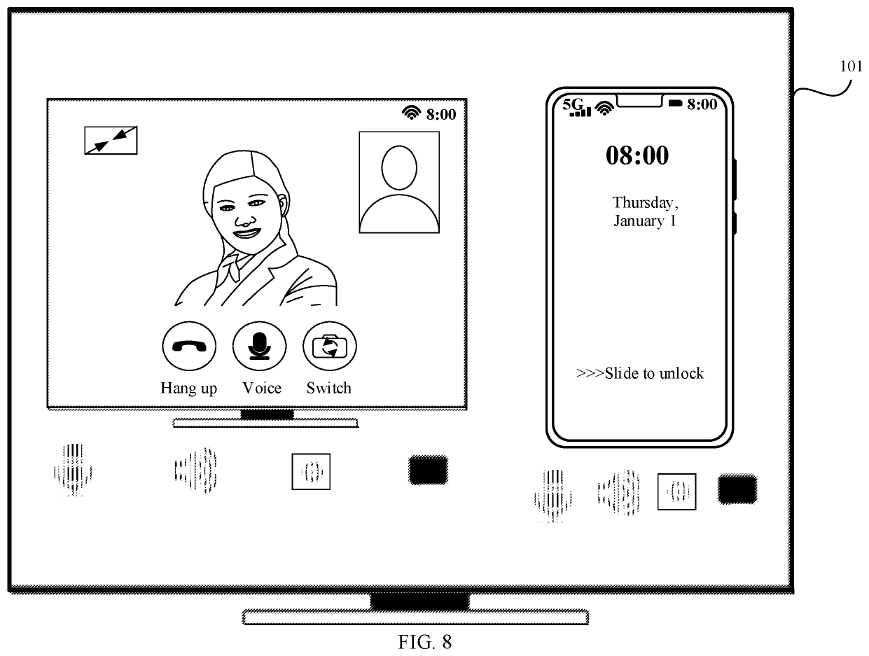

FIG. 7 shows another method for entering the logical device display interface by using the mobile phone 102.

The user may press and hold the screen on any display interface of the mobile phone 102 to enter the logical device display interface, and a position pressed by a finger may be any position on the screen.

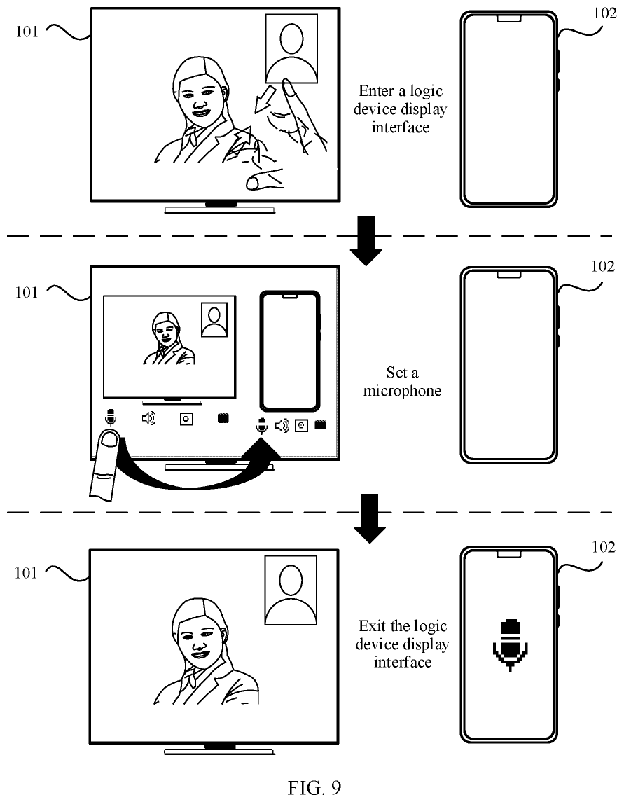

Display interfaces of virtual devices of the smart television 101 and the mobile phone 102 are shown in FIG. 8. Logical ports of the virtual devices of the smart television 101 and the mobile phone 102 are displayed below the virtual devices, and these logical ports may be displayed on the screen in a form of a 2D icon. Four 2D icons displayed below the virtual device of the smart television 101 are respectively a microphone, a speaker, a camera, and a screen from left to right, and four 2D icons displayed below the virtual device of the mobile phone 102 are respectively a microphone, a speaker, a camera, and a screen from left to right.

The logical port may alternatively be displayed on the screen in a form of a 3D model. If the user is currently using an AR device, the logical port of the 3D model may also be displayed to the user by using the AR device.

In some possible implementations, audio and a video in this embodiment of this application are separately managed. For example, a microphone and a speaker are mainly configured to collect and play audio, and may transmit original audio data during cross-device data transmission. For another example, the camera and the display are mainly configured to collect and play a video, and during cross-device data transmission, video data may be transmitted through video encoding and decoding.

In some possible implementations, the audio and the video in this embodiment of this application need to be simultaneously transmitted. In this case, an encapsulated projection protocol, an encapsulated audio/video transmission protocol, or the like is optionally used.

The smart television 101 may synchronously display a real-time status of each IoT device on a corresponding virtual device. As shown in FIG. 8, when the user is performing a video call by using the smart television 101, current video call content may be displayed on a virtual device of the smart television 101. When the mobile phone 102 is in a lock screen state, a lock screen image may be displayed on the virtual device of the mobile phone 102.

When the user needs to exit the logical device display interface, the user may tap a blank area of the logical device display interface to exit the logical device display interface, or may tap a virtual device to exit the logical device display interface, or may tap a virtual return key or a physical return key to exit the logical device display interface. A specific manner of exiting the logical device display interface is not limited in this application.

The foregoing describes in detail the method of entering and exiting the logical device display interface. The following describes an operation method of the logical device display interface.

A video call is a common application scenario. When a user performs a video call by using the smart television 101 or the mobile phone 102, the user can see an image of the other party by using a screen, and may further hear a voice of the other party by using a speaker. A voice and an image of the user may be transmitted to the other party by using a camera and a microphone.

The smart television 101 and the mobile phone 102 have different advantages in a video call. For example, a screen of the smart television 101 is larger, a camera angle of view is wider, and the mobile phone 102 features in flexible movement. A user can make video calls in different scenarios in specified manners to meet personalized requirements.

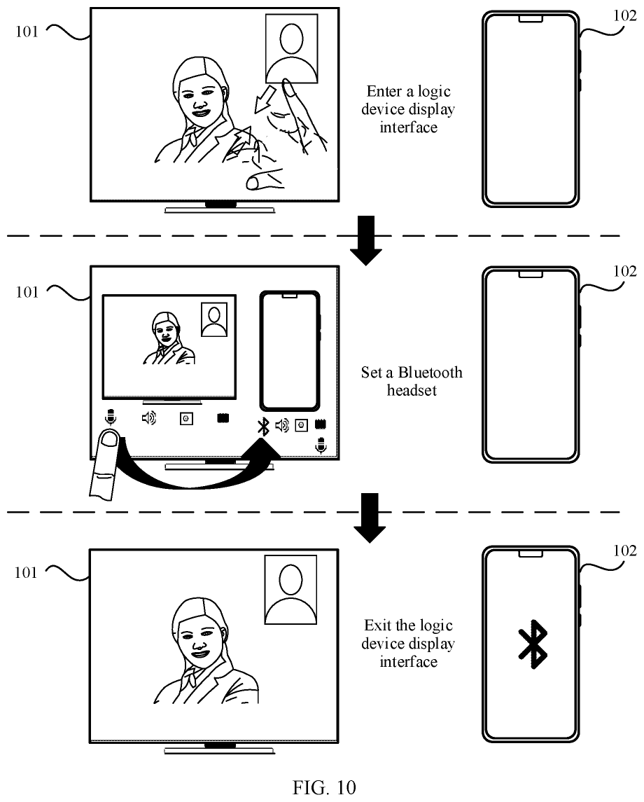

FIG. 9 shows a video call setting method. The user currently uses the smart television 101 to perform a video call. When the user is far away from the smart television 101, a voice pickup effect of a microphone of the smart television 101 is relatively poor, and the user may use a microphone of the mobile phone 102 to pick up a voice.

The user may perform a two-finger folding action in the air. After a camera of the smart television 101 captures the action, the logical device display interface is entered, and virtual devices of the smart television 101 and the mobile phone 102 are displayed. The user may select a microphone icon of the smart television 101, and perform a dragging operation in the air, to drag the microphone icon of the smart television 101 to a microphone icon of the mobile phone 102, or drag the microphone icon of the smart television 101 to a virtual device icon (“virtual device” for short) of the mobile phone 102. After detecting the dragging operation, the smart television 101 sends a request message to the mobile phone 102, to request to use the microphone of the mobile phone 102. After receiving the request message, the mobile phone 102 enables a voice pickup function, obtains a voice of the user, and transmits the voice of the user to the smart television 101. After obtaining audio data from the mobile phone 102, the smart television 101 may encapsulate the audio data and video data obtained by the smart television 101, and send the encapsulated audio data and video data to a peer end of the video call. In this embodiment, a current video call does not need to be closed for microphone function migration setting, thereby improving user experience.

Optionally, after migration of the microphone function is completed, the smart television 101 adds a connection line between the microphone icon of the smart television 101 and the microphone icon of the mobile phone 102. The mobile phone 102 may also display the microphone icon on the screen, to separately prompt the user that migration of the microphone function is completed between the smart television 101 and the mobile phone 102, thereby improving user experience.

After the microphone functions are migrated, the user can tap an exit button on the remote control to exit the logical device display interface.

In addition to migrating the microphone function of the smart television 101 to the mobile phone 102, the smart television 101 may further use a microphone and a speaker of a Bluetooth headset connected to the mobile phone 102, so that the user performs a video call when the user cannot hold the mobile phone 102 with both hands.

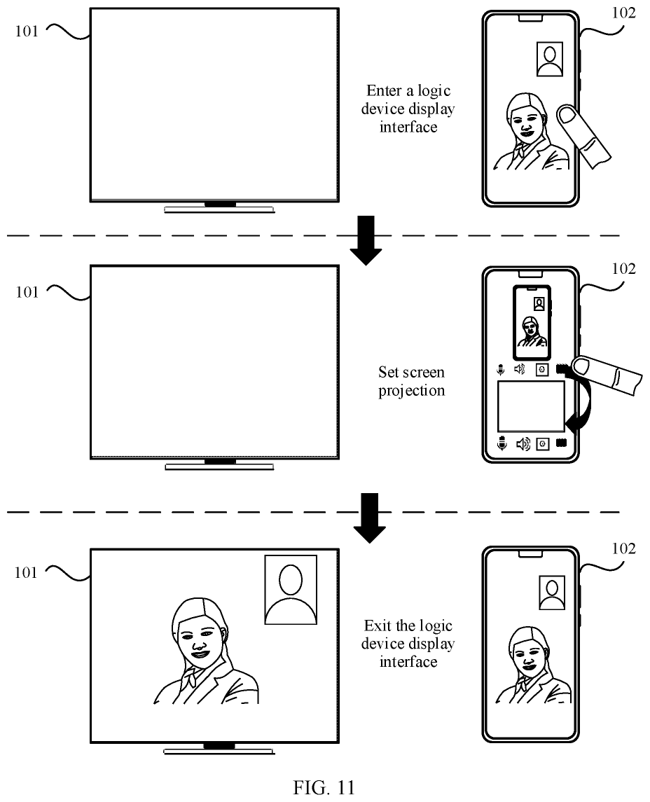

As shown in FIG. 10, the user may perform a two-finger folding action in the air. After the camera of the smart television captures the action, the logical device display interface is entered, and virtual devices of the smart television 101 and the mobile phone 102 are displayed. The mobile phone 102 is connected to the Bluetooth headset, and the virtual device of the mobile phone 102 includes a Bluetooth icon. The user may select the microphone icon of the smart television 101, and perform a dragging operation in the air. The user may drag the microphone icon and a speaker icon of the smart television 101 to the Bluetooth icon of the mobile phone 102 respectively, to indicate the mobile phone 102 to open the microphone and the speaker of the Bluetooth headset for the smart television 101 to use. Alternatively, the user may drag the microphone icon and a speaker icon of the smart television 101 to the virtual device of the mobile phone 102, and the mobile phone 102 determines whether to open the microphone and the speaker of the Bluetooth headset for the smart television 101 to use.

After detecting the operation of dragging the microphone icon, the smart television 101 sends a request message to the mobile phone 102, to request to use the microphone of the mobile phone 102. After receiving the request message, the mobile phone 102 enables a voice pickup function, obtains a voice of the user, and transmits the voice of the user to the smart television 101. After obtaining audio data from the mobile phone 102, the smart television 101 may encapsulate the audio data and video data obtained by the smart television 101, and send the encapsulated audio data and video data to a peer end of the video call.

After detecting the operation of dragging the speaker icon, the smart television 101 sends a request message to the mobile phone 102 again, to request to use the speaker of the mobile phone 102. After receiving the request message, the mobile phone 102 enables a speaker function, and plays audio data obtained from the smart television 101.

In the embodiment shown in FIG. 10, a current video call does not need to be closed for function migration setting of a microphone and a speaker, thereby improving user experience. After the function migration setting of the microphone and the speaker is completed, the user can tap the exit button on the remote control to exit the logical device display interface.

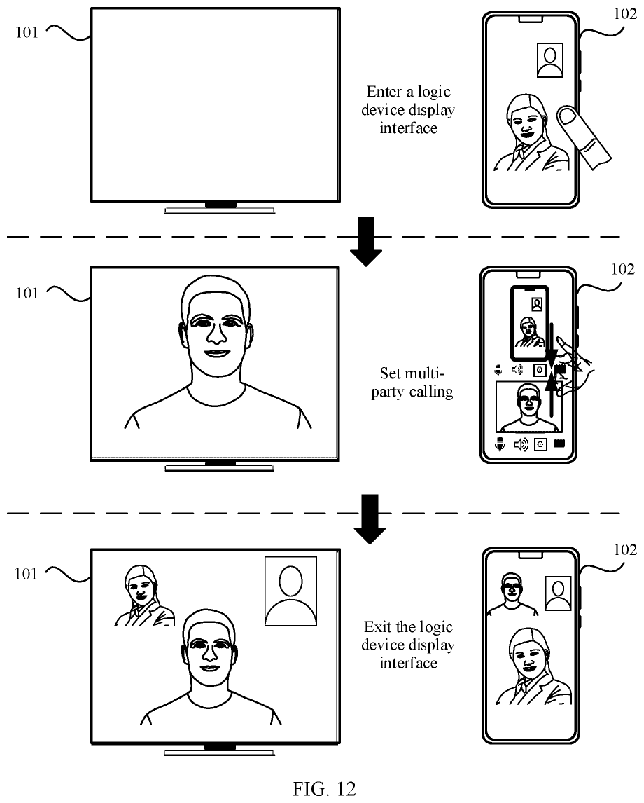

FIG. 11 shows another video call setting method. The user is currently using the mobile phone 102 to perform a video call. When the user is relatively close to the smart television 101, the user may use the screen of the smart television 101 to watch an image of the video call, so as to obtain a better visual effect.

The user may touch and hold the screen of the mobile phone 102. After detecting the action, the mobile phone 102 enters the logical device display interface, and displays the virtual devices of the smart television 101 and the mobile phone 102. The user may drag the screen icon of the mobile phone 102 to the virtual device of the smart television 101. The mobile phone 102 sends a request message to the smart television 101 based on the dragging operation, to request to project the image of the video call to the smart television 101. After receiving the request message, the smart television 101 enables a projection function, obtains video data of the video call from the mobile phone 102, and displays the image of the video call on the screen. The mobile phone 102 continues to process the audio data of the video call. In this embodiment, a current video call does not need to be closed for projection setting, thereby improving user experience.

After the projection setting is complete, the user can tap the blank area of the logical device display interface to exit the logical device display interface.

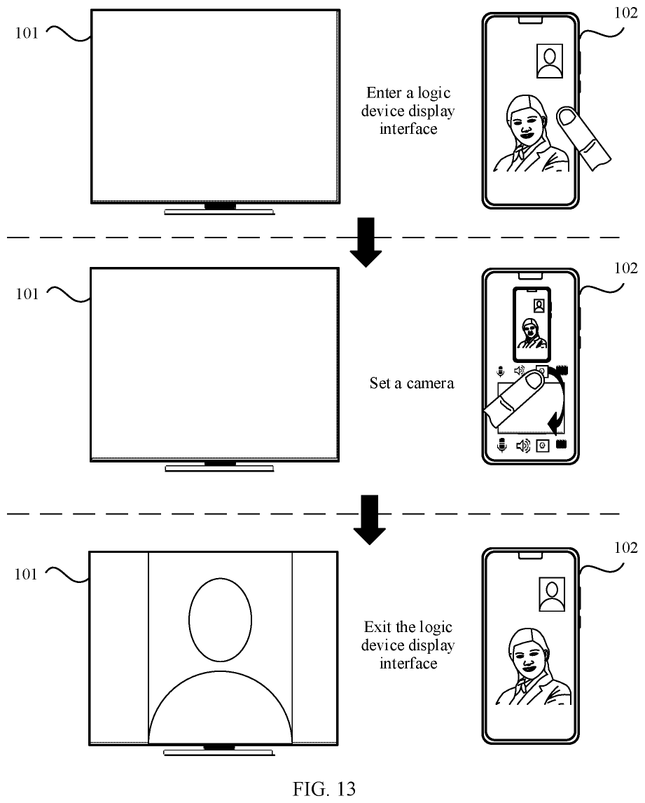

FIG. 12 shows still another video call setting method according to this application. The method is applied to a three-party video call scenario. A user A is currently performing a video call with a user C by using the mobile phone 102, and a user B wants to join the video call by using the smart television 101, where the user A and the user B are in a same geographical location.

The user A may touch and hold the screen of the mobile phone 102. After detecting the action, the mobile phone 102 enters the logical device display interface, and displays the virtual devices of the smart television 101 and the mobile phone 102. The user A may use two fingers to drag the virtual devices of the smart television 101 and the mobile phone 102 at the same time. After detecting the dragging operation, the mobile phone 102 sends a request message to the smart television 101, and requests, based on a currently running video call APP, the smart television 101 to share a microphone, a camera, and a speaker. After receiving the request message, the smart television 101 sends media data (for example, video data and audio data) of the user B to the mobile phone 102. The mobile phone 102 may package the media data of the user B and media data of the user A and send the media data to the user C. In addition, the media data of the user C and the media data of the user A are packaged and sent to the smart television 101, so that the user B joins the video call between the user A and the user C. Alternatively, the user A may use two fingers to drag camera icons of the smart television 101 and the mobile phone 102 at the same time, so that the smart television 101 and the mobile phone 102 separately share a camera. In this embodiment, a current video call does not need to be closed for video call setting, thereby improving user experience.

After the video call is set, the user can tap the blank area of the logical device display interface to exit the logical device display interface.

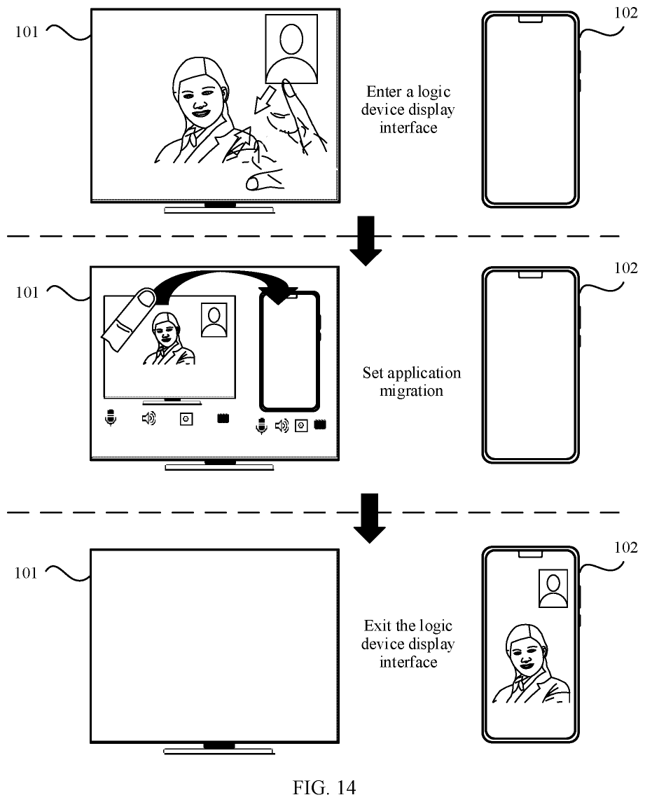

Similar to projection, when a user is performing a video call by using the mobile phone 102, the user may use a camera of the smart television 101, so that the other party can view an image with a wider view angle. A method for using the camera of the smart television 101 is shown in FIG. 13.

The user may touch and hold the screen of the mobile phone 102. After detecting the action, the mobile phone 102 enters the logical device display interface, and displays the virtual devices of the smart television 101 and the mobile phone 102. The user may drag the camera icon of the mobile phone 102 to the virtual device of the smart television 101. The mobile phone 102 sends, based on the dragging operation, a request message to the smart television 101, to request to obtain an image shot by the camera of the smart television 101. After receiving the request message, the smart television 101 starts the camera for shooting, and sends the shot image to the mobile phone 102. A local video image (a video image displayed in an upper right corner of the mobile phone 102) of the mobile phone 102 is the same as a video image displayed on the smart television 101. In this embodiment, a current video call does not need to be closed for camera setting, thereby improving user experience.

After the camera is set, the user can tap the blank area of the logical device display interface to exit the logical device display interface.

When a same APP is installed on the smart television 101 and the mobile phone 102, the user may migrate a state of the APP from the smart television 101 to the mobile phone 102, or the user may migrate a state of the APP from the mobile phone 102 to the smart television 101.

For example, the mobile phone 102 has a strong mobility advantage compared with the smart television 101, and the user may migrate an ongoing video call from the smart television 101 to the mobile phone 102 to obtain better mobility.

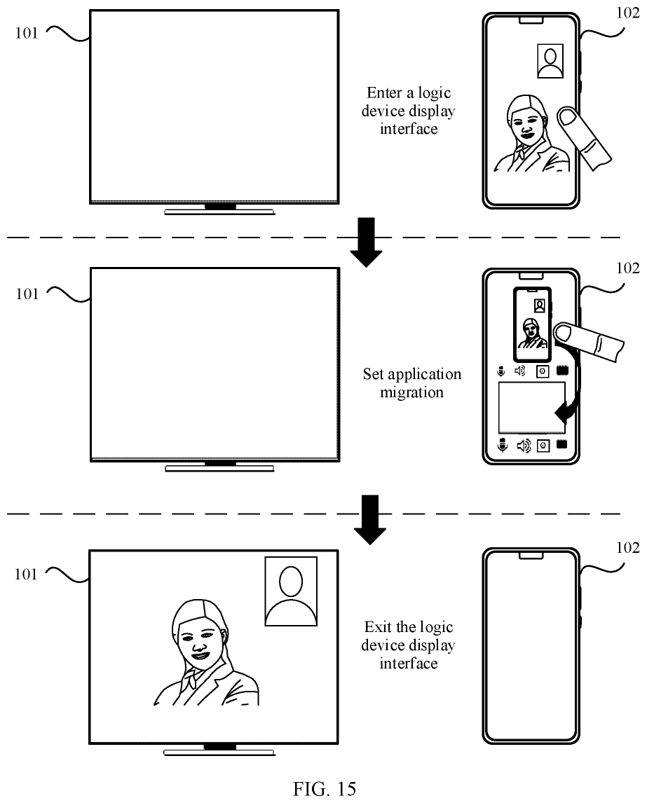

A process of migrating a video call is shown in FIG. 14. The user may perform a two-finger folding action on the screen of the smart television 101, to trigger the smart television 101 to enter the logical device display interface. Then, the user may tap a virtual device of the smart television 101, and drag the virtual device of the smart television 101 to a virtual device of the mobile phone 102. After detecting the dragging operation, the smart television 101 sends a request message to the mobile phone 102 to request to migrate the video call to the mobile phone 102. After receiving the request message, the mobile phone 102 executes a migration process of the video call. After the video call migration is completed, the virtual device of the mobile phone 102 displays a video call interface, and the virtual device of the smart television 101 removes a video call interface. In this embodiment, a current video call does not need to be closed for video call migration setting, thereby improving user experience.

After the APP is migrated, the user can tap the blank area of the logical device display interface to exit the logical device display interface.

In addition, compared with the mobile phone 102, the smart television 101 has an advantage of a large screen. A user may migrate an ongoing video call from the mobile phone 102 to the smart television 101 to obtain better visual experience.

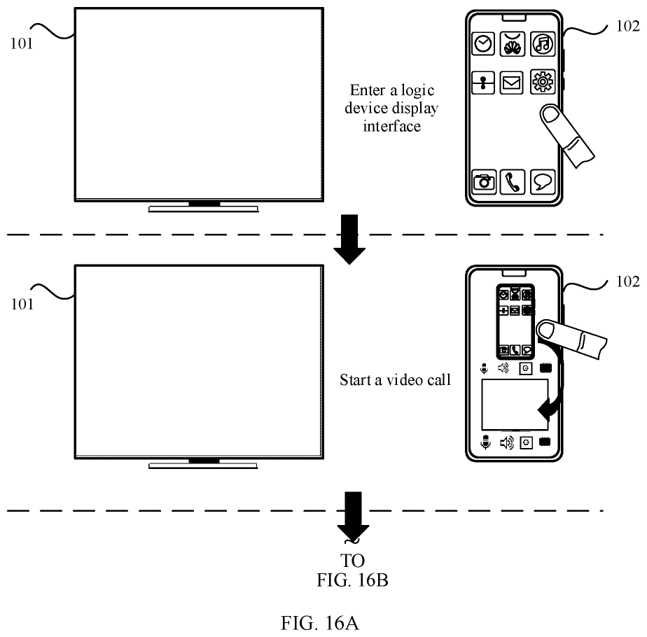

A process of migrating a video call is shown in FIG. 15. The user may press and hold the screen of the mobile phone 102 to trigger the mobile phone 102 to enter the logical device display interface. Then, the user may tap a virtual device of the mobile phone 102, and drag the virtual device of the mobile phone 102 to the virtual device of the smart television 101. After detecting the dragging operation, the mobile phone 102 sends a request message to the smart television 101 to request to migrate the video call to the smart television 101. After receiving the request message, the smart television 101 executes a migration process of the video call. After the video call migration is completed, the virtual device of the smart television 101 displays a video call interface, and the virtual device of the mobile phone 102 removes a video call interface. In this embodiment, a current video call does not need to be closed for video call migration setting, thereby improving user experience.

After the APP is migrated, the user can tap the blank area of the logical device display interface to exit the logical device display interface.

The foregoing describes some operation methods for the logical device display interface in the video call process. Better user experience may be obtained by further using the logical device display interface in a preparation phase of the video call.

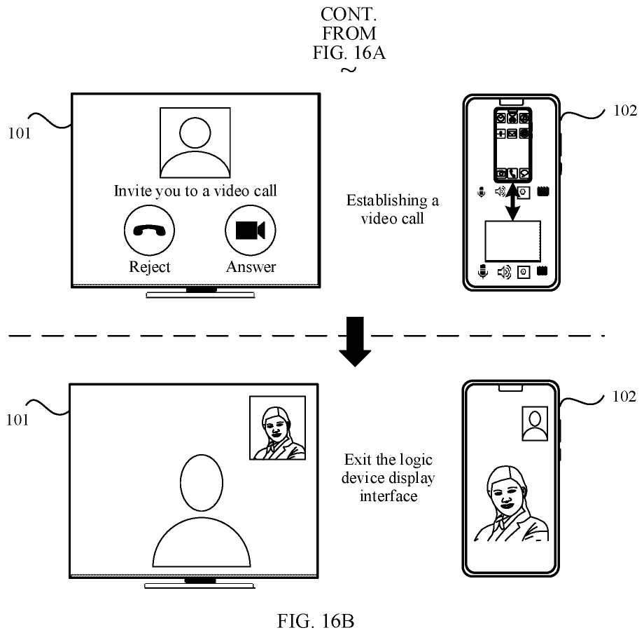

FIG. 16A and FIG. 16B show a method for establishing a video call. If the user wants to use the mobile phone 102 to establish a video call with the smart television 101, the user may perform an operation according to the following content.

The user may touch and hold the screen of the mobile phone 102. After detecting the action, the mobile phone 102 enters the logical device display interface, and displays the virtual devices of the smart television 101 and the mobile phone 102. When the mobile phone 102 is currently in a desktop display state, the user may drag the virtual device of the mobile phone 102 to the virtual device of the smart television 101. The mobile phone 102 sends, based on the dragging operation, a request message to the smart television 101, to request to obtain a video call connection to the smart television 101. After receiving the request message, the smart television 101 may display a video call establishment request dialog box on a screen, so that a user (for example, a family member of the user) of the smart television 101 chooses to accept or reject the video call. After receiving the request message, the smart television 101 may also directly establish a video call based on preset information, and send a shot image to the mobile phone 102, so that a user can see an environment (for example, a home environment of the user) in which the smart television 101 is located. In this embodiment, a video call is established in an intuitive manner, thereby improving user experience.

After the video call is established, the user can tap the blank area of the logical device display interface to exit the logical device display interface. When the user needs to exit the video call, the user may enter the logical device display interface again, and tap an arrow between the virtual device of the smart device 101 and the virtual device of the mobile phone 102 to disconnect the video call.

When the user has multiple residences, and there are smart televisions in the multiple residences, the user may establish a video call with a smart television in another residence by using a smart television in one residence.

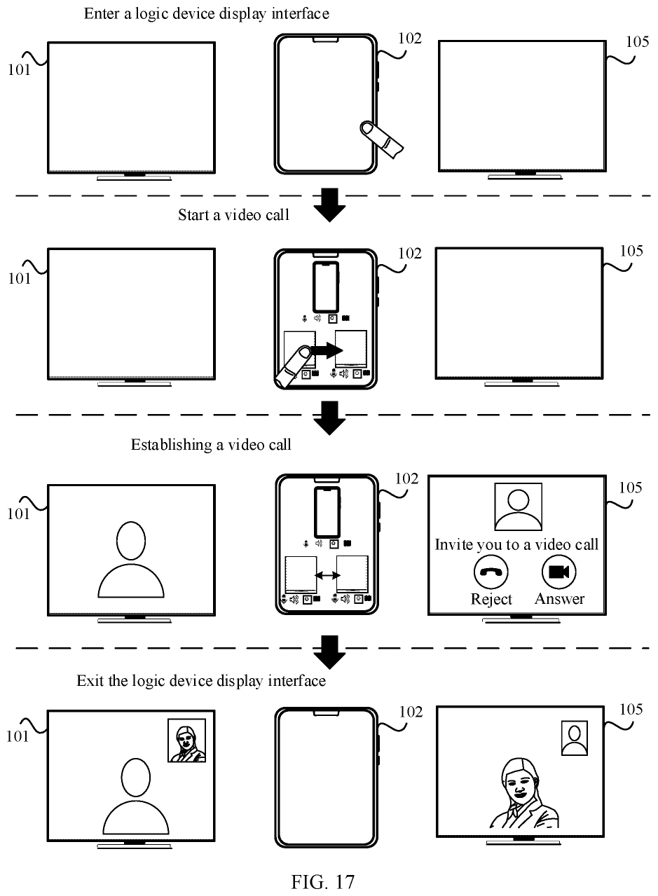

FIG. 17 shows another method for establishing a video call. The user, the smart television 101, and the mobile phone 102 are located in one residence, and a smart television 105 is located in another residence. If the user wants to use the mobile phone 102 to establish a video call between the smart television 101 and the smart television 105, the user may perform an operation according to the following content.

The user may touch and hold the screen of the mobile phone 102. After detecting the action, the mobile phone 102 enters the logical device display interface, and displays virtual devices of the smart television 101, the smart television 105, and the mobile phone 102. The user may drag the virtual device of the smart television 101 to the virtual device of the smart television 105. The mobile phone 102 sends, based on the dragging operation, a notification message to the smart television 101, to indicate the smart television 101 to establish a video call connection to the smart television 105. After receiving the notification message, the smart television 101 sends a video call establishment request to the smart television 105. After receiving the request message, the smart television 105 may display a video call establishment request dialog box on a screen, so that a user (for example, a family member of the user) of the smart television 105 chooses to accept or reject the video call. After receiving the request message, the smart television 105 may also directly establish a video call based on preset information, and send a shot image to the smart television 101, so that the user can see an environment in which the smart television 105 is located. In this embodiment, a video call is established in an intuitive manner, thereby improving user experience.

After the video call is established, the user can tap the virtual device of the mobile phone 102 or the blank area of the logical device display interface to exit the logical device display interface.

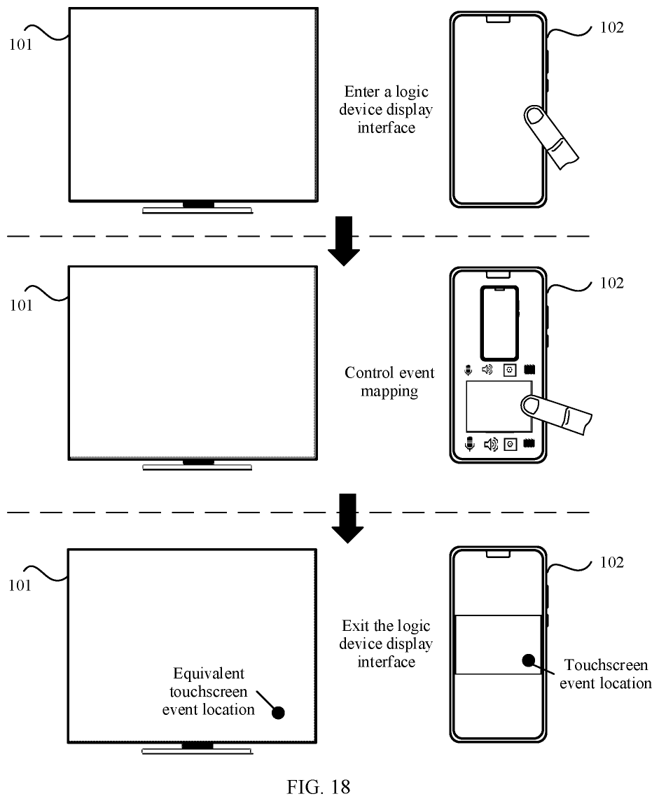

The foregoing describes some logical device display interface usage methods in a video call scenario. The user may also use the logical device display interface to perform other operations. For example, screens of some smart televisions are non-touchscreens, and it is inconvenient to input content on the smart television by using a remote control. The user may input content on the smart television by using a mobile phone. An operation method is shown in FIG. 18.

The user may touch and hold the screen of the mobile phone 102. After detecting the action, the mobile phone 102 enters the logical device display interface, and displays the virtual devices of the smart television 101 and the mobile phone 102. The user may tap the virtual device of the smart television 101. After detecting the tap action, the mobile phone 102 exits the logical device display interface and displays an image of the smart television 101 on the screen of the mobile phone. The mobile phone 102 further needs to map a control event to the smart television 101, that is, convert a touch event (TouchEvent) of the mobile phone 102 into a touch event of the smart television 101, so that a tap operation or an input operation may be performed on the smart television 101 by using the mobile phone 102. In a touch event conversion process, the mobile phone 102 may send coordinate information of the touch event of the mobile phone 102 to the smart television 101, and the smart television 101 performs mapping based on a screen parameter, to determine an equivalent position of the coordinate information on a screen, so as to generate a touch event corresponding to the equivalent position.

When the user needs to stop control of the mobile phone 102 on the smart television 101, the user may press and hold the screen of the mobile phone 102 again to enter the logical device display interface, and then tap the virtual device of the mobile phone 102 or the virtual device of the smart television 101 to stop control of the mobile phone 102 on the smart television 101.

The foregoing describes in detail an example of the IoT device management method provided in this application. It can be understood that, to implement the foregoing functions, a corresponding apparatus includes a corresponding hardware structure and/or software module for executing each function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In this application, functional unit division may be performed on an IoT device management apparatus based on the foregoing method examples. For example, functions may be divided into functional units, or two or more functions may be integrated into one unit. The foregoing integrated unit may be implemented in a form of hardware, or may be implemented in a form of a software functional unit. It needs to be noted that, in this application, division into the units is an example, and is merely a logical function division. During actual implementation, another division manner may be used.

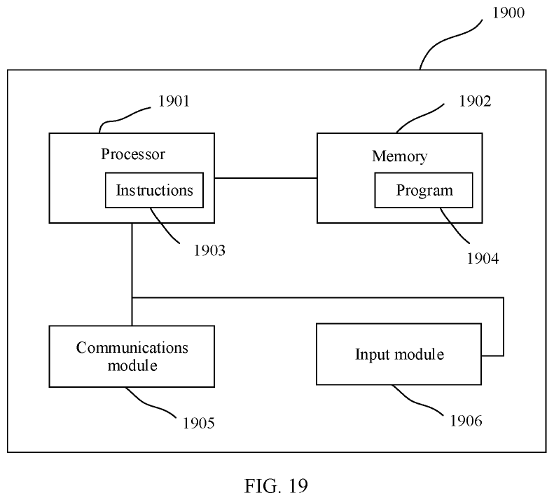

FIG. 19 is a schematic diagram of an electronic device for managing an IoT device according to this application. An electronic device 1900 may be configured to implement the methods described in the foregoing method embodiments.

The electronic device 1900 includes one or more processors 1901, and the one or more processors 1901 may support the electronic device 1900 in implementing the method in the method embodiments. The processor 1901 may be a general-purpose processor or a dedicated processor. For example, the processor 1901 may be a central processing unit (central processing unit, CPU). The CPU may be configured to control the electronic device 1900 and execute a software program, to implement a function of managing the IoT device.

The processor 1901 may be a digital signal processor (digital signal processor, DSP), an application specific integrated circuit (application specific integrated circuit, ASIC), a field programmable gate array (field programmable gate array, FPGA), or another programmable logic device, for example, a discrete gate, a transistor logic device, or a discrete hardware component. A specific type of the processor is not limited in this application.

The electronic device 1900 may further include a communications module 1905 and an input module 1906. The communications module 1905 is configured to implement input (receiving) and/or output (sending) of a signal between the electronic device 1900 and the IoT device. The input module 1906 is configured to implement a user input function.

For example, the communications module 1905 may be a transceiver or a communications interface of the electronic device 1900, and the electronic device 1900 sends or receives a wireless signal by using the transceiver, or the electronic device 1900 sends or receives a wired signal by using the communications interface. The wireless signal or the wired signal may be used to control the IoT device. The input module 1906 may be a touchscreen or a camera of the electronic device 1900, and the electronic device 1900 may obtain, by using the touchscreen or the camera, a triggering signal entered by a user.

The electronic device 1900 may include one or more memories 1902. The memory 1902 stores a program 1904. The program 1904 may be run by the processor 1901 to generate instructions 1903, to enable the processor 1901 to perform, according to the instructions 1903, the methods described in the foregoing method embodiments.

For example, the input module 1906 is configured to obtain a first triggering signal.

The processor 1901 is configured to: display a virtual device interface based on the first triggering signal, where the virtual device interface includes virtual device information of at least two Internet-of-things IoT devices.

The input module 1906 is further configured to obtain an operation signal, where the operation signal is a signal that is triggered by a user on the virtual device interface and that is used to control interaction between the at least two IoT devices.

The processor 1901 is further configured to perform a processing method corresponding to the operation signal.

Optionally, the memory 1902 may further store data (for example, virtual device information of the IoT device). Optionally, the processor 1901 may further read the data stored in the memory 1902. The data and the program 1904 may be stored at a same storage address, or the data and the program 1904 may be stored at different storage addresses.

The processor 1901 and the memory 1902 may be disposed separately, or may be integrated together, for example, integrated on a system on chip (system on chip, SOC).

It should be understood that steps in the foregoing method embodiments may be implemented by using a logical circuit in a hardware form or an instruction in a software form in the processor 1901. For a specific manner of performing the IoT device management method by the electronic device 1900 and beneficial effects generated by the method, refer to related descriptions in the method embodiments.

This application further provides a computer program product. When the computer program product is executed by the processor 1901, the method according to any method embodiment of this application is implemented.

The computer program product may be stored in the memory 1902. For example, the computer program product is a program 1904. After processing processes such as preprocessing, compilation, assembly, and linking, the program 1904 is finally converted into an executable target file that can be executed by the processor 1901.

This application further provides a computer-readable storage medium, which stores a computer program. When the computer program is executed by a computer, the method according to any method embodiment of this application is implemented. The computer program may be a high-level language program, or may be an executable target program.

The computer-readable storage medium is, for example, the memory 1902. The memory 1902 may be a volatile memory or a non-volatile memory, or the memory 1902 may include both a volatile memory and a non-volatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. By way of example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM).

It may be clearly understood by a person skilled in the art that, for ease and brevity of description, for a specific working process and a generated technical effect of the foregoing apparatus and device, refer to a corresponding process and technical effect in the foregoing method embodiments, and details are not described herein again.

In the several embodiments provided in this application, the disclosed system, apparatus, and method may be implemented in other manners. For example, some features of the method embodiments described above may be ignored or not performed. The described apparatus embodiments are merely examples. Division into the units is merely logical function division and may be other division in actual implementation. A plurality of units or components may be combined or integrated into another system. In addition, coupling between the units or coupling between the components may be direct coupling or indirect coupling, and the coupling may include an electrical connection, a mechanical connection, or another form of connection.

Sequence numbers of the foregoing processes do not mean execution sequences in various embodiments of this application. The execution sequences of the processes should be determined based on functions and internal logic of the processes, and should not be construed as any limitation on the implementation processes of the embodiments of this application.

In addition, the term “and/or” in this specification describes only an association relationship for associated objects and represents that three relationships may exist. For example, A and/or B may represent the following three cases: Only A exists, both A and B exist, and only B exists. In addition, the character “/” in this specification generally indicates an “or” relationship between the associated objects.

In conclusion, the foregoing descriptions are merely examples of embodiments of the technical solutions of this application, but are not intended to limit the protection scope of this application. Any modification, equivalent replacement, or improvement made without departing from the principle of this application shall fall within the protection scope of this application.

1.-21. (canceled)

22. An Internet-of-things device management method, comprising:
obtaining a first triggering signal;
displaying a virtual device interface based on the first triggering signal, wherein the virtual device interface comprises virtual device information of at least two Internet-of-things (IoT) devices;
obtaining an operation signal, wherein the operation signal is a signal that is triggered by a user input in the virtual device interface and that controls interaction between the at least two IoT devices; and
performing a processing operation corresponding to the operation signal.

23. The method according to claim 22, wherein the virtual device information of the at least two IoT devices comprises:
virtual device icons and logical port icons of the at least two IoT devices.

24. The method according to claim 23, wherein the at least two IoT devices comprise a first IoT device and a second IoT device;
the operation signal comprises:
dragging a logical port icon of the first IoT device to a virtual device icon of the second IoT device; and
the performing a processing operation corresponding to the operation signal comprises:
migrating a function corresponding to the logical port icon of the first IoT device to the second IoT device, wherein the second IoT device has the function corresponding to the logical port icon of the first IoT device.

25. The method according to claim 24, wherein the at least two IoT devices comprise a first IoT device and a second IoT device;
the operation signal comprises:
dragging a virtual device icon of the first IoT device to a virtual device icon of the second IoT device; and
the performing a processing operation corresponding to the operation signal comprises:
migrating a function of a target application of the first IoT device to the second IoT device, wherein the target application is an application that is running on the first IoT device, and the target application is installed on the second IoT device.

26. The method according to claim 22, wherein the at least two IoT devices comprise a first IoT device and a second IoT device;
the operation signal comprises:
dragging a virtual device icon of the first IoT device to a virtual device icon of the second IoT device; and
the performing a processing operation corresponding to the operation signal comprises:
establishing a communication connection between a target application of the first IoT device and the target application of the second IoT device, wherein the first IoT device does not run the target application before obtaining the operation signal.

27. The method according to claim 22, wherein the at least two IoT devices comprise a first IoT device and a second IoT device;
the operation signal comprises:
two-finger-dragging a logical port icon of the first IoT device and a logical port icon of the second IoT device for combination; and
the performing a processing operation corresponding to the operation signal comprises:
sharing a function of the logical port icon of the first IoT device and a function the logical port icon of the second IoT device.

28. The method according to claim 23, wherein the at least two IoT devices comprise a first IoT device and a second IoT device;
the operation signal comprises:
tapping a virtual device icon of the second IoT device; and
the performing a processing operation corresponding to the operation signal comprises:
establishing a control event mapping relationship between the first IoT device and the second IoT device, wherein the first IoT device is a preset control device, and the second IoT device is a controlled device.

29. The method according to claim 22, wherein the obtaining a first triggering signal comprises:
obtaining the first triggering signal by using a touchscreen, wherein the first triggering signal is a triggering signal generated in response to a preset action on the touchscreen.

30. The method according to claim 22, wherein the obtaining a first triggering signal comprises:
obtaining the first triggering signal by using a camera, wherein the first triggering signal is a triggering signal generated in response to a preset action in the air.

31. The method according to claim 22, wherein the method further comprises:
obtaining a second triggering signal; and
exiting the virtual device interface based on the second triggering signal.

32. An electronic device for managing an Internet-of-things device, comprising:
at least one processor; and
one or more memories coupled to the at least one processor and storing programming instructions for execution by the at least one processor to cause the electronic device to:
obtain a first triggering signal;
display a virtual device interface based on the first triggering signal, wherein the virtual device interface comprises virtual device information of at least two Internet-of-things (IoT) devices;
obtain an operation signal, wherein the operation signal is a signal that is triggered by a user input on the virtual device interface and that controls interaction between the at least two IoT devices; and
perform a processing operation corresponding to the operation signal.

33. The electronic device according to claim 32, wherein the virtual device information of the at least two IoT devices comprises:
virtual device icons and logical port icons of the at least two IoT devices.

34. The electronic device according to claim 33, wherein the at least two IoT devices comprise a first IoT device and a second IoT device;
the operation signal comprises:
dragging a logical port icon of the first IoT device to a virtual device icon of the second IoT device; and
wherein the programming instructions, when executed by the at least one processor, cause the electronic device to:
migrate a function corresponding to the logical port icon of the first IoT device to the second IoT device, wherein the second IoT device has the function corresponding to the logical port icon of the first IoT device.

35. The electronic device according to claim 33, wherein the at least two IoT devices comprise a first IoT device and a second IoT device;
the operation signal comprises:
dragging a virtual device icon of the first IoT device to a virtual device icon of the second IoT device; and
wherein the programming instructions, when executed by the at least one processor, cause the electronic device to:
migrate a function of a target application of the first IoT device to the second IoT device, wherein the target application is an application that is running on the first IoT device, and the target application is installed on the second IoT device.

36. The electronic device according to claim 33, wherein the at least two IoT devices comprise a first IoT device and a second IoT device;
the operation signal comprises:
dragging a virtual device icon of the first IoT device to a virtual device icon of the second IoT device; and
wherein the programming instructions, when executed by the at least one processor, cause the electronic device to:
establish a communication connection between a target application of the first IoT device and a target application of the second IoT device, wherein the first IoT device does not run the target application before obtaining the operation signal.

37. The electronic device according to claim 33, wherein the at least two IoT devices comprise a first IoT device and a second IoT device;
the operation signal comprises:
two-finger-dragging a logical port icon of the first IoT device and a logical port icon of the second IoT device for combination; and
wherein the programming instructions, when executed by the at least one processor, cause the electronic device to:
share a function of the logical port icon of the first IoT device and a function the logical port icon of the second IoT device.

38. The electronic device according to claim 33, wherein the at least two IoT devices comprise a first IoT device and a second IoT device;
the operation signal comprises:
tapping a virtual device icon of the second IoT device; and
wherein the programming instructions, when executed by the at least one processor, cause the electronic device to:
establish a control event mapping relationship between the first IoT device and the second IoT device, wherein the first IoT device is a preset control device, and the second IoT device is a controlled device.

39. The electronic device according to claim 32, wherein the electronic device comprises a touchscreen, and the programming instructions, when executed by the at least one processor, cause the electronic device to:
obtain the first triggering signal by using the touchscreen, wherein the first triggering signal is a triggering signal generated in response to a preset action on the touchscreen.

40. The electronic device according to claim 32, wherein the electronic device comprises a camera, and the programming instructions, when executed by the at least one processor, cause the electronic device to:
obtain the first triggering signal by using the camera, wherein the first triggering signal is a triggering signal generated in response to a preset action in the air.

41. A non-transitory computer-readable storage medium, wherein the computer-readable storage medium stores a computer program, and when the computer program is executed by a processor, the processor is enabled to perform following steps:
obtaining a first triggering signal;
displaying a virtual device interface based on the first triggering signal, wherein the virtual device interface comprises virtual device information of at least two Internet-of-things (IoT) devices;
obtaining an operation signal, wherein the operation signal is a signal that is triggered by a user input in the virtual device interface and that controls interaction between the at least two IoT devices; and
performing a processing operation corresponding to the operation signal.
